(19) United States
(12) Patent Application Publication
(10) Pub. No.: US 2015/0381965 A1
(43) Pub. Date: Dec. 31, 2015

(54) SYSTEMS AND METHODS FOR DEPTH MAP EXTRACTION USING A HYBRID ALGORITHM

(71) Applicant: QUALCOMM Incorporated, San Diego, CA (US)

(72) Inventors: Kalin Mitkov Atanassov, San Diego, CA (US); Sergiu Radu Goma, San Diego, CA (US); Hasib Ahmed Siddiqui, San Diego, CA (US)

(21) Appl. No.: 14/642,523

(22) Filed: Mar. 9, 2015

Related U.S. Application Data
(60) Provisional application No. 62/018,392, filed on Jun. 27, 2014.

(51) Int. Cl. H04N 13/02; G06T 7/00; H04N 5/232

(52) U.S. Cl. CPC H04N 13/0271; H04N 5/23245; G06T 7/0051; H04N 13/0239

(57) ABSTRACT

Aspects relate to methods of generating a high-resolution image containing object depth information. A method may include capturing a first image of an object using a first camera, the first image including light projected in a known pattern on the object, extracting depth information at a first resolution from the first image, the depth information extracted based on a pattern of the projected light in the first image and capturing a second image of the scene using a second camera, the second image captured at a second resolution which is higher than the first resolution. The method also includes aligning geometries of the first and second image based on a known difference in location of the first camera and the second camera and using the second image to up-sample the depth information from the first resolution to a third resolution, the third resolution is higher than the first resolution.

### CROSS REFERENCE TO RELATED APPLICATIONS

This application claims the benefit of U.S. Provisional Application No. 62/018,392, filed Jun. 27, 2014, entitled “SYSTEMS AND METHODS FOR DEPTH MAP EXTRACTION USING A HYBRID ALGORITHM,” the entire contents of which are hereby incorporated by reference herein.

### TECHNICAL FIELD

The present disclosure relates to hybrid algorithms for depth map extraction. In particular, the disclosure relates to systems and methods that enable a high-resolution image to be used to up-sample a depth map that has been created using another technique, such as an active sensing technique.

### BACKGROUND

Depth maps may be useful for a number of different functions. However, it may be difficult to generate high-resolution, accurate depths maps. Certain techniques may be used to generate accurate low-resolution depth maps, but these techniques cannot easily generate high-resolution depth maps due to limitations in transmitting light onto a scene with sufficient resolution and accuracy. As such, systems and methods are needed for providing depth maps which are both accurate and at a high resolution.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

Depth sensing may be done at imaging resolutions that are lower than common optical imaging resolutions. This may be due to limitations of a near infrared transmitter of a structured light system, the transmitter projecting a near infrared pattern onto a scene. In some embodiments, a depth map generated by active sensing techniques may be converted into a higher-resolution depth map. For example, this may be done by determining initial depth information (e.g., a depth map) of a scene from a first (lower resolution) image. Then, adjusting the depth information by re-rendering the depth information as if it were taken from the point of view (i.e., the projected FOV) of a camera that captured a (higher resolution) second image of the scene, such that the re-rendered depth information is aligned with the second image (of the same scene as the depth map). Then, the depth map may be upsampled to produce a resolution higher than that of the initial depth information. For example, by aligning one or more features identified in an initial (low-resolution) depth map with the same one or more features in a high (or higher) resolution optical image (for example, an RGB image or a black and white image) of the same scene, the depth map data may be accurately upsampled such that the resulting depth map has a higher resolution than the initial depth map, and the optical image (or RGB image) is used to adjust the upsampled depth information (for example, enhance or correct edges).

One innovation includes a method of generating a high-resolution image containing depth information of an object, the method including capturing a first image of a scene using a first camera, the captured image including light projected in a known pattern on the scene, determining depth information at a first resolution from the first image, capturing a second image of the scene using a second camera, the second image captured at a second resolution which is higher than the first resolution, adjusting the depth information to be from a different viewpoint, and up-sampling the depth information, using the second image, from the first resolution to a third resolution to generate depth information at the third resolution, the third resolution higher than the first resolution.

In some aspects, adjusting the depth information to be from a different viewpoint may include re-rendering the depth information as if the first image was taken from the second camera position. Adjusting the depth information to be from a different viewpoint may include re-rendering the depth information from the first image after adjusting the first image based on at least one difference in a projected field-of-view of the first camera and a projected field-of-view the second camera. The depth information may include a depth map, and wherein up-sampling the depth information comprises using edge information in the second image to adjust at least a portion of the depth map. The first image may depict codes reflected from at least one object illuminated by a structured light transmitter, and the second image may be formed from visible light. The method mat further include projecting light in a known pattern on the scene. The third resolution may be substantially equal to the second resolution. The method may include determining at least one difference between a position and field of view of the first camera and the second camera, and adjusting the depth information may be based on the at least one difference. The first image may include a near infrared image and the second image may include a color image. In some aspects, the known pattern may be produced by a diffractive optical element positioned to receive a light beam emitted from a laser, the diffractive optical element including a plurality of diffractive features configured to produce the known pattern when the light beam from the laser propagates through the diffractive optical element.

One aspect of the present disclosure provides a depth sensing system, including a transmitter configured to project a known pattern of light, a receiver comprising a sensor assembly configured to capture a first image of an object illuminated by the known pattern of light, the first image being at a first resolution, a camera positioned proximate to the receiver, the camera configured to capture a second image of the object using visible light, and a processor configured to determine depth information at a first resolution from the first image, the depth information determined based at least in part on the known pattern of light, adjust the depth information to be from a viewpoint of the camera, and up-sample the depth information, using the second image, from the first resolution to a third resolution to generate depth information at a third resolution, the third resolution being higher than the first resolution.

In one aspect, the present disclosure provides a device for generating a high-resolution image containing depth information of an object, the device including a first camera configured to capture a first image of a scene, the captured image including light projected in a known pattern on the scene, a second camera configured to capture a second image of the scene, the second image captured at a second resolution which is higher than a first resolution, a processor configured to determine depth information at the first resolution from the first image, the depth information determined based at least in part on a pattern of the projected light in the first image, adjust the depth information to be from a different viewpoint, and up-sample the depth information, using the second image, from the first resolution to a third resolution to generate depth information at the third resolution, the third resolution higher than the first resolution.

One aspect of the present disclosure provides a device for generating a high-resolution image containing depth information of an object, the device including means for capturing a first image of a scene using a first camera, the captured image including light projected in a known pattern on the scene, means for determining depth information at a first resolution from the first image, means for capturing a second image of the scene using a second camera, the second image captured at a second resolution which is higher than the first resolution, means for adjusting the depth information to be from a different viewpoint, and means for up-sampling the depth information, using the second image, from the first resolution to a third resolution to generate depth information at the third resolution, the third resolution higher than the first resolution.

### BRIEF DESCRIPTION OF THE DRAWINGS

FIG. 1 is a schematic illustrating an example of a structured light transmitter.

FIG. 2 is a schematic illustrating an example of a camera (radiation receiver).

FIG. 3 illustrates an exemplary method of generating a depth map using an active sensing camera and a high resolution camera.

FIG. 4 is an illustration of a transmitter and camera setup according to one aspects of the present application.

FIG. 5 is a data flow diagram illustrating the creation of a high-resolution depth map based on a lower-resolution NIR image and a high-resolution color image.

FIG. 6 is an exemplary diagram of a method of generating a high-resolution image containing depth information of an object.

FIG. 7A illustrates a representation of a true color image containing a number of objects.

FIG. 7B shows an illustration of the various component bands found in FIG. 7A, generated by taking a Fourier transform of FIG. 7A with wide support, from −π to +π.

FIG. 8A illustrates a representation of a true color image containing a number of objects, and was generated in a manner similar to certain methods contained in this disclosure.

FIG. 8B is an illustration of the various component bounds found in FIG. 8A, generated by taking a Fourier transform of FIG. 8A.

FIG. 9A illustrates an example of a depiction of a disparity map generated using a global minimization method, such as an active sensing technique operating at a high resolution.

FIG. 9B is an example of an illustration of a Fourier Transform of the disparity map of FIG. 9A.

FIG. 10A is an illustration of a disparity map that has been produced through linear interpolation, but without the use of edge sharpening.

FIG. 10B is an illustration of a Fourier Transform of the disparity map of FIG. 10A produced through linear interpolation.

FIG. 11A is an illustration of a disparity map which has been produced by upsampling a smaller disparity map and using guided filtering to sharpen the edges based upon a high-resolution image.

FIG. 11B is an illustration of a Fourier Transform of the disparity map of FIG. 11A produced through linear interpolation.

FIG. 12 is an illustration in the use of a modified smallest univalue segment assimilating nucleus (SUSAN) filter to up-sample a depth map using a high-resolution image.

FIGS. 13A and 13B are illustrations of frequency responses of the SUSAN filter, at two different locations in FIG. 12.

### DETAILED DESCRIPTION

Various aspects of the novel systems, apparatuses, and methods are described more fully hereinafter with reference to the accompanying drawings. The teachings disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

In the following description, specific details are given to provide a thorough understanding of the examples. However, the examples may be practiced without these specific details. In addition, certain aspects of embodiments described herein may be included in other embodiments as well, as one having ordinary skill in the art will appreciate.

Active sensing can be used to determine three dimensional models for depth map extraction. In some embodiments, multiple active sensing devices may be used to collect depth information of an object that can be used to form a three dimensional (3D) model of the object. Active sensing systems may include, for example, time-of-flight systems and structured light systems. Passive sensing may include multiple RGB cameras to capture information and determine depth (for example, through the use of stereo image pairs). Each of an active sensing and a passive sensing approach may have certain advantages and disadvantages. However, using aspects of both techniques together may result in higher-resolution, more accurate depth maps than using either technique individually.

Implementations disclosed herein provide systems, methods and apparatus for generating images that can be used to collect information to form a 3D model (or a depth map) of an object, or of a scene that includes the (at least one) object. For example, the model may comprise a depth map. A depth map may include information ordered in the same (or similar) form as a regular image, for example, it may have data ordered representing an X by Y array of pixels, but the value of each pixel may be related to a distance (or depth) between the camera and an object that would be depicted in an image at the position at those locations, rather than an intensity or color value. In some cases a depth map may be displayed as in image, and the depth information may be represented as a color when the image is displayed. For example, in some embodiments a depth map may use a darker tone or color to represent objections which are further away, and a lighter tone or color to represent objects which are closer to the camera, or vice versa. Such a depth map may be used for many purposes. For example, a depth map may be used for computer vision and camera quality enhancement, as well as for other purposes. Accordingly, it may be desirable to create high quality depth maps and so improved systems and methods for depth map creation may be desired.

One method of creating a depth map is to use an active sensing system. An “active sensing system” (or “active sensing”) is a broad term and can be used to generally describe a sensing system that is configured to illuminate at least one object in a scene with radiation, and then receive radiation that is reflected from the object. Examples of active sensing systems may include, but are not limited to, structured light systems and time-of-flight (TOF) systems. “Structured light” is a broad term, and can be used to generally describes a process of projecting a known pattern of symbols (for example, grids or bars, and sometimes referred to as a “codemask”) onto a scene. The reflection of the projected symbols is captured by a sensor (e.g., a camera) in one or more images.

Examples of a TOF systems include, but are not limited to, a TOF camera. A TOF camera is configured to determine a distance from the TOF camera to one or more objects in a scene. In one example, a TOF camera transmits IR radiation to one or more portions of a scene (for example, to illuminate one or more objects on the scene) and then calculates the distance to an object based on the known speed of light. That is, the TOF camera measures the time the transmitted radiation takes to propagate go to the object, reflect from the surface of the object and propagate back to the TOF camera. Using the known speed of light, the TOF can then determine the distance to the object.

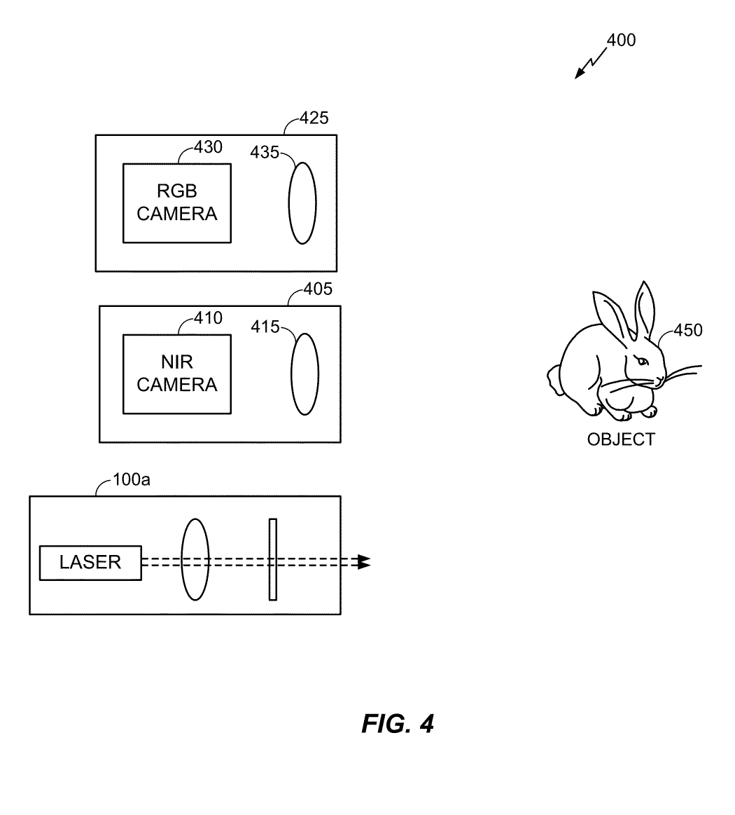

A structured light system projects a known pattern (for example, symbols, grids or geometric shapes) onto a scene, that is, onto at least one object that is in the scene. The way that the pattern changes or deforms when striking surfaces in the scene allows vision systems to calculate the depth and surface information of the objects in the scene. A structured light system includes a projection component (a transmitter) and a receiver component (as illustrated in FIG. 4). A pattern is projected by the transmitter onto an object (or onto a scene) using a stable light source, such as a laser. An imaging system receiver (for example, a camera) may be positioned at a known offset from the transmitter. In some embodiments, the receiver is configured to know the projected pattern. The receiver includes a sensor configured to receive radiation reflected from an object illuminated by the projected radiation (for example, light) pattern. The receiver may have knowledge of the pattern and knowledge of the offset distance and direction. The receiver can be configured to receive radiation reflected from the scene and determine a distance from the structured light system to one or more of objects in an image depicting the field of view of the receiver. The distance may be determined based on deformation of the pattern projected onto the objects. In some embodiments, the receiver captures images that include the projected radiation and another component (for example, a processor) determines depth information using the captured images. In some embodiments, the radiation used may not be visible to the human eye, for example, the radiation may be in the ultraviolet, infrared, or near infrared radiation.

To determine a 3D model of an object, multiple images having different viewpoints of the object may be collected. Post-processing of the multiple images can produce the 3D model. The post-processing may be near-real time if fast enough computers and techniques are employed for the post processing of the multiple images. In some aspects, a single image may also be used to generate a depth map, based on the difference in positions between the transmitter and the camera.

Such active sensing systems may be used to generate very accurate and reliable depth maps of a scene. However, one issue with these depth maps is that they may have relatively low resolution when compared to resolutions which are used in digital imaging. This relatively low resolution may be a result of the methods used in active sensing systems. For example, it may take approximately three to four pixels of camera resolution in order to determine a single pixel of resolution in a depth map generated on a structured light system. In various embodiments, the transmitter resolution may be more limiting than the camera resolution. The resolution of the depth map may be limited by the capabilities of the transmitter to transmit a given pattern. As the desired resolution of the depth map grows larger, the pattern that the transmitter must transmit will need to include smaller and smaller details. These details must be transmitted accurately onto the scene, or else the depth map may not be accurate. Accordingly, a digital camera (“camera”) may be able to have a significantly higher resolution than the resolution of an “image” generated from a structured light system.

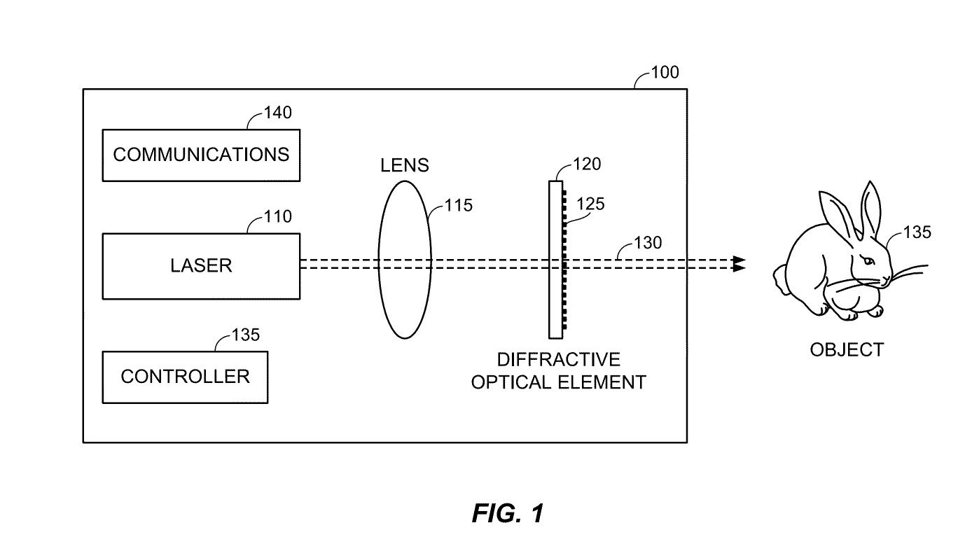

FIG. 1 is a schematic illustrating an example of a structured light transmitter 100, which is part of one active sensing technique for generating a depth map. The transmitter 100 includes a laser 110 that produces a near infrared light beam 130. In some aspects, other wavelengths of light may also be used for this purpose in addition to or instead of near infrared. The transmitter 100 also includes a collimating lens 115 and a diffractive optical element (or mask) 120 aligned such that the light beam 130 passes through the collimating lens 115 and then through the diffractive optical element 120 prior to hitting the object 135. Diffractive features 125 on the diffractive optical element 120 produce a light pattern that is projected onto an object 135 (illustrated here as a rabbit). This light pattern may thus be projected onto the object 135, and may be observed by a receiver, which may capture an image of the object 135 from a slightly different angle. Depth information may be calculated based upon the projected pattern on the object 135.

Generally, near infrared (NIR) light is radiation that has a wavelength of about 700 nanometers to about 1 mm. The laser 110 may be configured to produce a NIR beam in a very narrow spectrum of wavelengths, for example, within a narrow range of about 1-5 nanometers of wavelengths. Accordingly, the projected light from a NIR transmitter 100 may differ by about 1-5 nm in wavelength. In some aspects, producing a narrow range of wavelengths may be beneficial. For example, this may allow the pattern to be more accurately projected onto the scene. The illustrated laser 110 includes a controller 135 configured to control the laser 110 to emit pulses of light of a certain pulse width and a certain frequency. In addition, the transmitter 100 can include a communication module 140 and may include a processor. The communication module 140 may be configured to communicate information with other devices to coordinate the length of a pulse width, the frequency of the pulse width, and when to emit the pulse of light. For example, the transmitter 100 may be configured to communicate this information via the communication module 140 to a receiver, for example, a digital camera, that may be used to capture an image of the scene including the projected light generated by the laser 110.

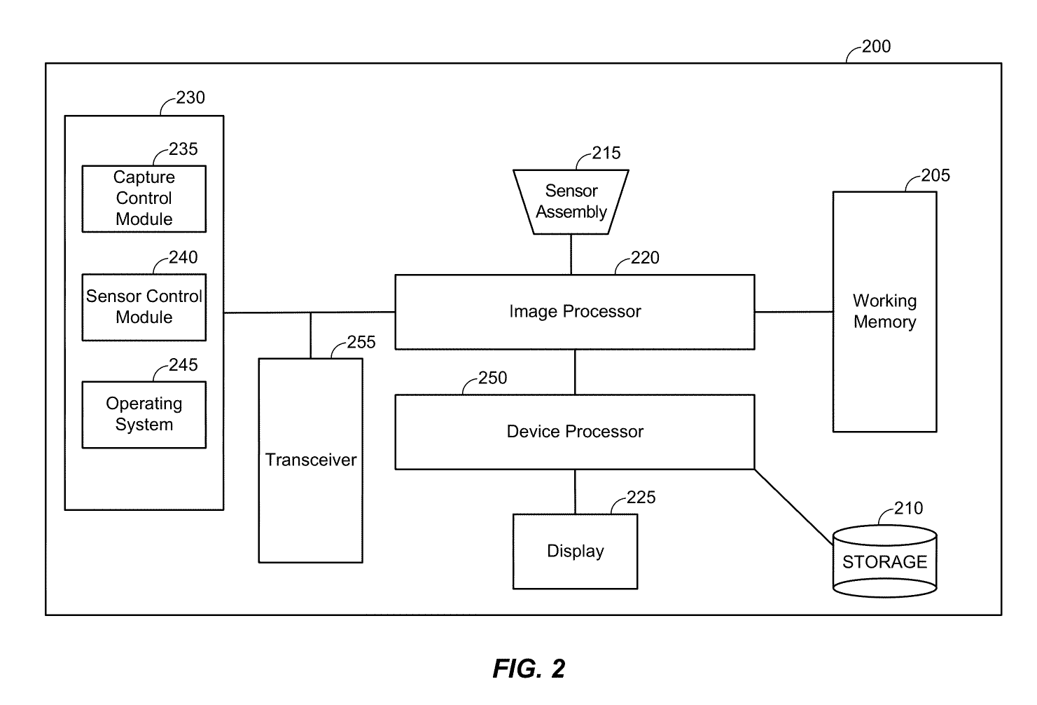

FIG. 2 is a schematic diagram illustrating an example of an image capture device, (or camera) 200, according to some embodiments of the disclosure. In some embodiments, functionality described as being incorporated in camera 200 may reside on, and be performed by, another device that obtains images captured by the camera 200.

The camera 200 may include multiple components, including an image processor 220, which is in communication with an image sensor assembly 215, a transceiver 255, a working memory 205, and a memory 230 that may be configured with instructions to operate a processor to achieve certain functionality, and a device processor 250. In some embodiments, the image processor 220 and the device processor may be combined in the same chip or chipset. As illustrated in the embodiment of FIG. 2, the device processor 250 is in communication with electronic storage 210 and an electronic display 225.

In some embodiments, the image device 200 may be a sensing device purposely configured for structured light depth sensing. In some embodiments, device 200 may be a general-purpose device, such as a cell phone, digital camera, tablet computer, personal digital assistant, or the like. Device 200 may also be a stationary computing device. A plurality of applications may be available to the user on device 200. These applications may include traditional photographic and video applications, high dynamic range imaging, panoramic photo and video, or stereoscopic imaging such as 3D images or 3D video. In some embodiments, the image capture device 200 may also include the transmitter 100 in the same housing.

In the embodiment of FIG. 2, the image capture device 200 includes the image sensor assembly 215 for capturing images. The image sensor assembly 215 may include a sensor, lens assembly, and a primary and secondary reflective or refractive surface for redirecting a portion of a target image to each sensor. The image sensor assembly 215 may include two or more sensors. The image sensor assembly 215 may be coupled to the image processor 220 to transmit captured image to the image processor 220.

The image processor 220 may be configured to perform various processing operations on received image data comprising N portions of the target image in order to output a high quality stitched image, as will be described in more detail below. The image processor 220 may be a general purpose processing unit or a processor specially designed for imaging applications. Examples of image processing operations include cropping, scaling (for example, to a different resolution), image stitching, image format conversion, color interpolation, color processing, image filtering (for example, spatial image filtering), lens artifact or defect correction, etc. Image processor 220 may, in some embodiments, comprise a plurality of processors. Certain embodiments may have a processor dedicated to each image sensor. The image processor 220 may be one or more dedicated image signal processors (ISPs) or a software implementation of a processor.

As shown, the image processor 220 is connected to a memory 230 and a working memory 205. In the illustrated embodiment, the memory 230 stores capture control module 235, sensor module 240, and operating system 245. These modules include instructions that configure the image processor 220 and/or the device processor 250 to perform various image processing and device management tasks. The device processor 250 may include working memory and/or may use storage 210 as working memory. Working memory 205 may be used by image processor 220 to store a working set of processor instructions contained in the modules of memory 230. Alternatively, working memory 205 may also be used by image processor 220 to store dynamic data created during the operation of device 200.

Still referring to the embodiment illustrated in FIG. 2, the image processor 220 may be configured by several modules stored in the memory. The capture control module 235 may include instructions that configure the image processor 220 to adjust the focus position of imaging sensor assembly 215. Capture control module 235 may further include instructions that control the overall image capture functions of the device 200. For example, capture control module 235 may include instructions that call subroutines to configure the image processor 220 to capture raw image data of a target image scene using the imaging sensor assembly 215. Capture control module 235 may be configured to control the sensor module 240 to perform a stitching technique on the partial images captured by various image capture devices and output a stitched and cropped target image to imaging processor 220. Capture control module 235 may also be configured to control the sensor assembly 215 to capture an image, for example, in coordination with the transmitter emitting laser pulse and in coordination with other image capture devices.

Operating system module 245 configures the image processor 220 to manage the working memory 205 and the processing resources of device 200. For example, operating system module 245 may include device drivers to manage hardware resources such as the imaging sensor assembly 215. Therefore, in some embodiments, instructions contained in the image processing modules discussed above may not interact with these hardware resources directly, but instead interact through standard subroutines or APIs located in operating system component 270. Instructions within operating system 245 may then interact directly with these hardware components. Operating system module 245 may further configure the image processor 220 to share information with device processor 250.

Device processor 250 may be configured to control the display 225 to display the captured image, or a preview of the captured image, to a user. The display 225 may be external to the imaging device 200 or may be part of the imaging device 200. The display 225 may also be configured to provide a view finder displaying a preview image for a use prior to capturing an image, or may be configured to display a captured image stored in memory or recently captured by the user. The display 225 may comprise an LCD or LED screen, and may implement touch sensitive technologies.

Device processor 250 may write data to storage module 210, for example data representing captured images. While storage module 210 is represented graphically as a traditional disk device, those with skill in the art would understand that the storage module 210 may be configured as any storage media device. For example, the storage module 210 may include a disk drive, such as a floppy disk drive, hard disk drive, optical disk drive or magneto-optical disk drive, or a solid state memory such as a FLASH memory, RAM, ROM, and/or EEPROM. The storage module 210 can also include multiple memory units, and any one of the memory units may be configured to be within the image capture device 200, or may be external to the image capture device 200. For example, the storage module 210 may include a ROM memory containing system program instructions stored within the image capture device 200. The storage module 210 may also include memory cards or high speed memories configured to store captured images which may be removable from the camera. Transceiver 255 can be configured to communicate information with other image capture devices to determine each device should capture an image.

Although FIG. 2 depicts a device 200 having separate components to include a processor, imaging sensor, and memory, one skilled in the art would recognize that these separate components may be combined in a variety of ways to achieve particular design objectives. For example, in an alternative embodiment, the memory components may be combined with processor components to save cost and improve performance.

Additionally, although FIG. 2 illustrates two memory components, including memory component 230 comprising several modules and a separate memory 205 comprising a working memory, one with skill in the art would recognize several embodiments utilizing different memory architectures. For example, a design may utilize ROM or static RAM memory for the storage of processor instructions implementing the modules contained in memory 230. The processor instructions may be loaded into RAM to facilitate execution by the image processor 220. For example, working memory 205 may comprise RAM memory, with instructions loaded into working memory 205 before execution by the processor 220.

In addition to active sensing techniques, other technologies may also be used to create a depth map. Another technique for creating a depth map may be to use two or more cameras which capture images of the same scene at the same time but at slightly different angles. In some aspects, this may be an example of a passive technique. Such a passive technique may be so-named because the technique passively observes a scene, without projecting light or other information onto the scene itself.

When multiple images are captured, these images may be compared with each other in order to identify common elements in the two images. For example, certain parts of the image may be identified based on distinctive colors or changes in brightness or other factors. These same portions may be identified in each of the captured images. Next, the location of these points with respect to each other in the various images may be compared. For example, points which may be closer to the cameras may vary in location between different images more than points which are further from the cameras. Based on difference in relative location of these common elements, a depth map may be generated. This technique may be referred to as a passive sensing technique, as it does not require a transmitter (for example, a laser) to transmit a grid or other light onto a given scene in order to determine a depth map.

Passive sensing techniques may have certain advantages and certain disadvantages compared to various active sensing techniques. For example, passive sensing techniques may be able to operate at significantly higher resolutions. Active sensing techniques may operate at relatively low resolutions, such as 320×240 or 640×480. In contrast, a passive sensing technique may be able to operate at the resolution of the cameras themselves. For example, cameras which are configured with sensors sized to be 10, 15, 18 megapixels or more may be used. Accordingly, passive sensing technologies may be able to generate a much higher resolution depth map than active sensing technologies. However, in some ways, this higher-resolution depth map may not be as accurate or as versatile as a depth map generated using an active sensing technology. For example, passive sensing requires that the system be able to identify and distinguish multiple points on at least two images. The system may work to identify a large number of unique points of the first image, find the corresponding point on the second image, and generate a depth map based upon these two corresponding points. However, such a system may be much less reliable, or fail to work, when the subject images include portions which have a constant color patch or area, or gradual color gradients. In those areas, it may be much more difficult or impossible for the system to reliably locate the same point on two different images. Thus, while passive sensing may be accurate and reliable on areas with a lot of depth and color discontinuities, passive sensing may be less reliable where there are constant color patches. In contrast, active sensing technology may be well-suited to such constant color patches and areas, but may offer only a limited resolution.

Thus, passive technologies offer some advantages, such as higher possible resolution, but also some disadvantages, such as lower reliability and accuracy in certain situations. Accordingly, in some aspects, it may be beneficial to use both an active sensing device and a high resolution camera together, in order to create an accurate, high-resolution depth map. By using an active sensing technique, an accurate depth map may be generated. When this depth map is combined with a high-resolution image, it may be possible to obtain an accuracy comparable to an active sensing technique, but a resolution comparable to a passive sensing technique.

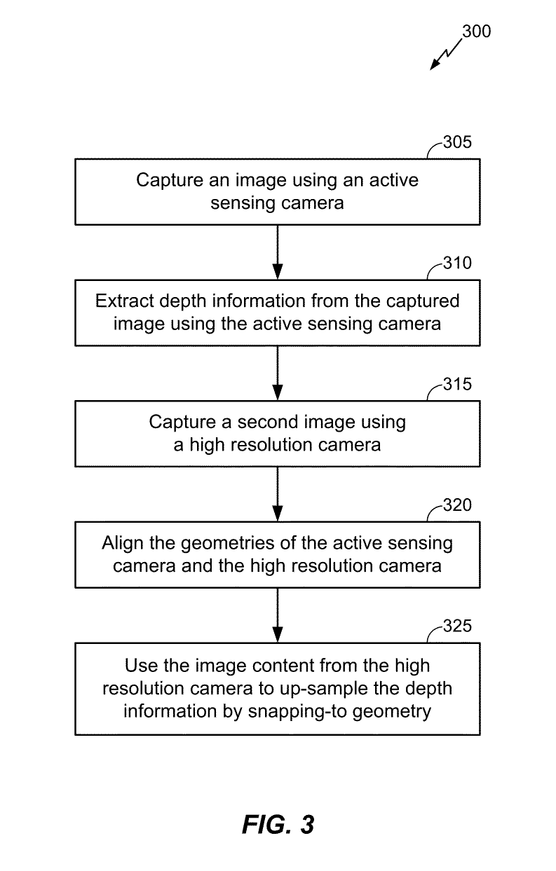

FIG. 3 illustrates an example of a process 300 for generating a depth map using an active sensing camera and a high resolution camera. This process 300 may be carried out by a device such as device 200, and may generate a depth map with a resolution higher than what is generated by the active sensing camera when used alone. For example, this process 300 may be carried out by a device which includes both an active sensing camera (transmitter and receiver) and a high-resolution camera. In various embodiments, this innovation may generate a depth map with a resolution of approximately 2 megapixels, 5 megapixels, 10 megapixels, 15 megapixels or more.

First, at block 305, the process 300 includes capturing an image using an active sensing camera. For example, the active sensing camera may be a structured light device, or a time of flight device. Either of these systems may involve a transmitter which transmits radiation onto a scene, and a receiver which receives radiation reflected from objects in the scene. Because the camera is disposed in the system at a (slightly) different physical location than the transmitter, a projected field-of-view (FOV) of the camera that includes the scene is projected from a (slightly) different angle than the projected FOV of the transmitter. Reflected radiation from the scene that includes radiation from the transmitted may be slightly changed or deformed by objects in the scene that have depth, as captured by the receiver. Accordingly, the camera (receiver) may observe variations in the pattern based upon the depth of the observed scene, and these variations may be used to determine depth information of the objects in the scene. In some embodiments, two or more cameras may be used, which may also enable the images captured by each camera to be compared to one another in order to determine depth in that manner as well. When two or more cameras are used, it may be desirable to place the two or more cameras in such a position as to capture the same scene but at different angles. It may also be desirable for the two or more cameras, when multiple cameras are used, to capture their images simultaneously or in very close temporal proximity to one another. In some aspects, the means for capturing the image may include a transceiver or a receiver.

At block 310, the process 300 includes extracting depth information from the captured image using the active sensing camera. For example, the active sensing camera may be configured, as discussed above, to generate a depth map based on captured image or images. For example, a depth map may be an image in which the color or luminance of given pixels is not related to the true colors of those areas of a scene, but rather to the distance between the camera and those objects. The resolution of the depth map may be low due to, for example, limitations on the transmitter used in an active sensing camera. In some aspects, the means for extracting depth information may include a processor.

At block 315, the process 300 includes capturing a second image of the scene using a high resolution camera. For example, the high resolution camera may be placed as close as possible to the NIR camera used for the active sensing above, in order to allow the high-resolution camera and the NIR camera to capture the scene from as similar a position as possible. The second image, captured by the high-resolution camera, may be an RGB image. For example, the high-resolution camera may be similar to a digital camera or cell phone camera. It may be beneficial if the NIR (active sensing) camera and the high-resolution camera capture images simultaneously, or in very close temporal proximity to each other. This physical and temporal proximity may allow the two cameras to capture similar scenes—both from nearly the same position and with a similar (but not identical) projected FOV. In some embodiments, radiation that is received for the active sensing system (for example, NIR) and radiation that is received for the high resolution camera system (for example, visible light) is received through the same aperture and/or the lens assembly, and then propagated to different sensors. In such cases, an active sensing image and a high resolution optical image may be captured from exactly the same position so the active sensing image and the high resolution image are more easily aligned. In some aspects, multiple high resolution cameras may also be used to capture the scene. The means for capturing the second image may include a camera.

At block 320, the process 300 includes adjusting the depth information (or depth map) as if it were generated from the position of the high resolution camera. Because the active sensing camera and the high resolution camera may be separate devices, they may take images from slightly different angles. It may be beneficial to place these cameras as close together as possible, in order to minimize the difference in angles between the two cameras. However, even when these cameras are placed very close together, the depth information from the active sensing image and the high resolution image may still need to be aligned properly correspond, so that edge information in the high definition image can be used for to adjust (enhance and/or correct) edges in the depth information. The adjustment of the depth information will result in a better alignment of the depth information and the high resolution image means aligning the depth information captured and the image captured by the high resolution camera, such that objects (features) that are in the depth information are aligned with the same objects (features) in the high resolution image.

Aligning the depth information to appear to be have been taken from a camera in the same position and having the same FOV as the optical image may result in digitally altering the depth information to be aligned at the same (or substantially the same) location (for example, pixel row and column) as in the optical (high resolution) image. This alignment (or translation) may be possible based on the depth information extracted from the image captured by the active sensing camera. Accordingly, the image captured by the active sensing camera may be altered to align it with a higher resolution optical image. Such an alteration may be possible, at least in part, due to the depth information contained in the depth map. For example, the depth map may be used to generate a 3D model of the scene, and the point-of-view of the camera may be altered slightly based upon this 3D model. It may still be beneficial for the two cameras to be as close together as possible, as the accuracy of this point-of-view change may be higher when the change is smaller.

At block 325, the process 300 includes using content (for example, features) from the image from the high resolution camera to up-sample the depth information to determine depth information having a higher resolution. This may be done, for example, by using the aligned depth information and higher resolution (optical) image. The depth information may be of a lower resolution than the high-resolution image. Accordingly, because the images from the two devices are aligned, the process 300 may up-sample the depth information based on the aligned high-resolution image. For example, the system may be configured to identify color and light intensity differences between different portions of the high-resolution image (for example, edges) and use these differences to up-sample the depth information based on these differences. For example, if a depth of a number of portions of the high-resolution image are known, based on the low-resolution depth map, the method may use colors, brightness, edges, and other factors to determine high-resolution depth information based on the high-resolution image and the low-resolution depth information. In some aspects, the means for up-sampling may include a processor.

In some aspects, this technique may have a number of advantages over previous techniques. For example, this technique may be reliable on flat patches, and be reliable when faced with depth and color discontinuities. Further, this technique may enable the creation of a depth map which is both high-quality and high-resolution.

Using this technique may also allow a system to maintain a final depth map resolution, while adjusting the power and the resolution used by the active sensing camera and the transmitter. This is because the resolution of the final depth map need not be the same as the resolution of the transmitter and active sensing camera. For example, this may allow a lower-resolution active sensing technique to be used, which may reduce power consumption and/or cost, while allowing the device to generate a high-resolution depth map.

These techniques may also give a device the ability to use the final depth map for camera enhancement operations. For example, this depth map may be used for digital aperture synthesis, such as adding or increasing the bokeh effect in an image (that is, making the background to a scene blurrier, simulating the use of a different lens). Further, this technique may allow the ability to overlay color on top of depth images. A number of other applications, such as point-of-view changes, may also become possible or easier when high-resolution depth maps of an image are available.

FIG. 4 is an illustration of a transmitter and camera setup 400 according to one aspects of the present application. The setup 400 includes a near infrared transmitter 100a, configured to transmit a near infrared pattern onto an object 450. For example, this pattern may include a striped or a spotted pattern. The setup also includes a NIR camera component 405, which may include, for example, a lens 415 and a NIR camera 410. For example, the NIR camera component 405 may be similar to device 200. The NIR camera component 405 may be configured to capture one or more images of the object 450, and may be configured to detect the pattern transmitted by the NIR transmitter 100a onto the object 450. Accordingly, the setup 400 may be configured to generate a depth map based on the one or more images captured by the NIR camera component 405. In some aspects, multiple NIR camera components may be used to capture multiple NIR images.

The setup further includes a RGB camera component 425, which is configured to capture a high-resolution RGB image of the object 450. The RGB camera component 425 may include, for example, an RGB camera 430 and a lens 435. In some aspects, the RGB camera component 425 may be placed as close to the NIR camera component 405 as possible. For example, both components may be quite small, and may be placed very close together. It may be beneficial for the components to be placed close together, as this may allow the images captured by the NIR camera component 405 to be more easily altered to match the perspective of the RGB camera component 425. The RGB camera component 425 may be used to capture an image of the object 450, and this image may be used to up-sample the depth map created based on the image from the NIR camera component 405, as described above.

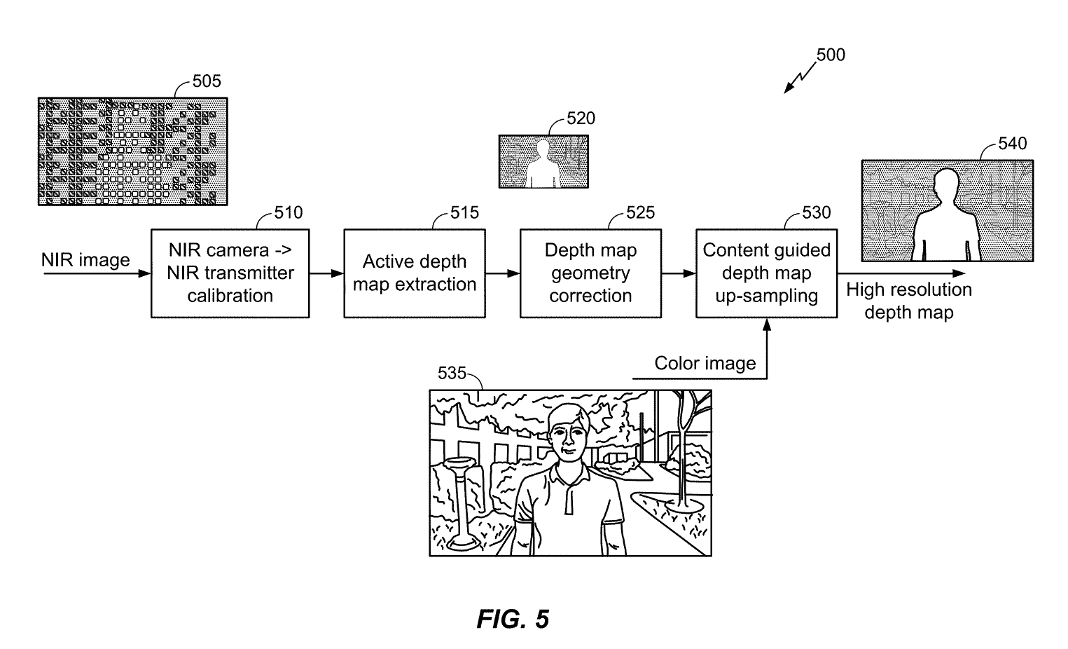

FIG. 5 is a data flow diagram 500 illustrating the creation of a high-resolution depth map based on a lower-resolution NIR image and a high-resolution color image.

First, a near infrared image 505 is captured. For example, the NIR image 505 may be captured by a NIR camera, and may be an image of an object. The object may have a NIR pattern projected onto it. For example, as illustrated, the pattern may be a dot pattern projected onto the object and the background from a slightly different angle than the angle of the NIR camera. In some aspects, the pattern may also be a grid pattern, a striped pattern, symbols, or another pattern. This pattern may be projected by a NIR transmitter, as described above. The NIR transmitter may use a laser or other technology to transmit the pattern onto the scene.

Next, the NIR camera location and the NIR transmitter location may be calibrated with one another. For example, the NIR camera may be placed, for example, one inch (or any other distance) from the NIR transmitter, in a known direction. For example, both the NIR camera and the NIR transmitter may be permanently placed inside a larger device, such that that the NIR camera and the NIR transmitter may be permanently placed a known distance and direction from each other. Based upon this known distance and direction, the NIR camera and NIR transmitter may be calibrated with each other. This calibration may use this known distance and direction between the camera and the transmitter in order to align the optical axes of the NIR transmitter and receiver to be in a known arrangement. For example, this may make the optical axes of the transmitter and the receiver parallel, which may be useful for extracting depth information about the scene.

Next, a depth map 520 may be extracted, using active depth map extraction 515 based on the NIR image 505. As shown in the diagram 500, but depth map 520 may be smaller in pixel size than the NIR image 505. This is because the NIR image 505 may need three or four pixels (or more) of information for each one pixel in the depth map 520 because, in order to extract a depth map from the NIR image 505, it may be necessary to identify and distinguish between individual portions of the pattern projected onto the object (for example, stripes or a dotted pattern). It may take multiple pixels of information in the NIR image 505 in order to accurately distinguish the portions of the pattern, and thus, the depth map 520 may be of a lower resolution than the NIR image 505 used to create the depth map 520. For example, the depth map 520 may be created by using the embedded structure in the transmitter mask (for example, the pattern that the transmitter transmits such as a dot or striped pattern) to estimate the depth of various objects in the NIR image 505.

After creating the depth map 520, the depth map 520 geometry may be corrected 525. For example, the depth map 520 generated from the NIR image 505 may be from the perspective of the NIR camera. It may be desirable to digitally alter the perspective of the depth map to match the perspective of the RGB camera. This may be possible due, at least in part, to the depth information contained within the depth map 520. Such depth information may make it easier to slightly alter the perspective of the depth map 520, while retaining a high degree of accuracy. In some aspects, it may be desirable to place the NIR camera and the RGB camera as close to each other as possible in order to minimize the amount of perspective change which may be needed. Both the RGB camera and the NIR camera may be permanently affixed in a larger device a known distance and direction apart. Accordingly, the geometry correction of the depth map 520 may be based, at least in part, on the known distance and direction from the RGB camera to the NIR camera. For example, in some aspects, based on the depth information contained in the depth map 520, the depth map 520 may be re-rendered as if it was taken from the RGB camera's point of view.

Next, the process may use a color image 535 captured by the RGB camera in order to perform a content-guided depth map up-sampling 530. For example, the color image 535 may be taken by an RGB camera, and may be a high-resolution color image. Note that it isn't necessary that the high-resolution image be stored or taken in RGB format, and other formats may also be used. The color image 535 may be compared to the re-rendered depth map 520, and points from the color image 535 may be aligned with corresponding portions of the re-rendered depth map. Accordingly, a high resolution depth map 540 may be created based on the color image 535 and the re-rendered depth map 520. This high-resolution depth map 540 may be as large in pixels as the color image 535, and may be significantly higher-resolution than the depth map 520. Up-sampling the depth map 520 may include, for example, using the color image 535 to enhance and correct the edges of the depth map 520 when up-sampling. For example, the colors of the color image 535 may be used to determine the edge of certain portions of the photo and the beginning of other portions.

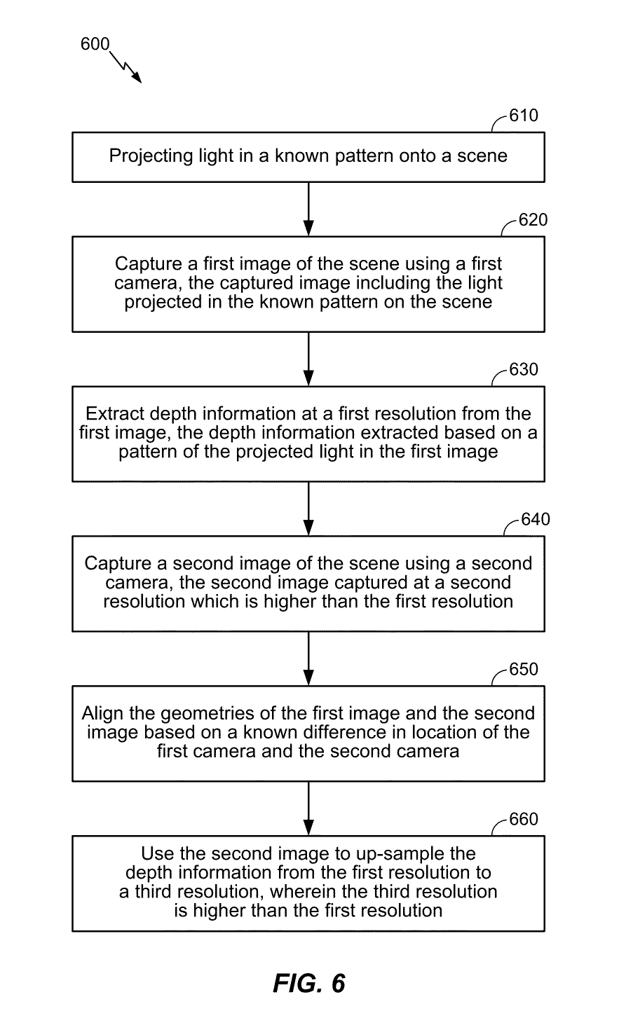

FIG. 6 is an exemplary diagram 600 of a method of generating a high-resolution image containing depth information of an object.

At block 610, the method includes projecting light in a known pattern onto a scene. For example, the light may be near infrared light. The light may be projected onto a scene using a pattern created by a diffractive optical element. In some aspects, the light may be projected using a laser. In some aspects, the means for projecting light may include a light element, such as an LED, a light bulb, or a laser.

At block 620, the method includes capturing a first image of a scene using a first camera, the captured image including light projected in a known pattern on the scene. For example, the first camera may be a near infrared camera. This camera may operate at a first resolution, such as a relatively low resolution. In some aspects, the means for capturing a first image may include a camera, such as a near infrared camera or another type of camera.

At block 630, the method includes extracting depth information at a first resolution from the first image, the depth information extracted based on a pattern of the projected light in the first image. For example, the depth information may be extracted at a resolution that is lower than the resolution of the first camera. The depth information may have a limited resolution, in part, due to limitations of the transmitter or laser than is transmitting light in the known pattern, and limitations of the first camera. For example, as described above, it may take multiple pixels of image information from the first camera to make a single pixel of depth information. In some aspects, the depth information may be constructed based on time of flight or structured light techniques. For example, the depth information may be constructed based on deformations of the known pattern on the object, the deformations based on the depth of the object and based on a difference in position between the first camera and the light element which is projecting the light. This difference in position may be known, for example, because the camera and the light element may be permanently affixed to a larger structure, such that the two elements do not move with respect to one another. In some aspects, the means for extracting depth information may include a processor.

At block 640, the method includes capturing a second image of the scene using a second camera, the second image captured at a second resolution which is higher than the first resolution. In some aspects, the second camera may be a high resolution, true color camera. For example, the second camera may use a resolution like those found in modern digital imaging, such as 10 megapixels, 15 megapixels, 20 megapixels or more. Other resolutions may also be used, as desired. In some aspect, the second camera may be placed as close to the first camera as possible. The second camera may be configured to capture the second image contemporaneously with the capture of the first image. For example, the two images may be captured at the same time, using a similar exposure length. The positioning of the cameras and timing of the images may allow the two images to capture a scene which is as similar as possible. In some aspects, the means for capturing the second image may be a second camera, such as a high resolution camera.

At block 650, the method includes aligning the geometries of the first image and the second image based on a known difference in location of the first camera and the second camera. For example, these images may be aligned using the depth information from the first image, along with information on the distance between the first and second cameras. For example, this depth information may be used to “translate” the first image, such that the first image may appear to have been taken from a slightly different perspective, such as from the perspective of the second camera. In some aspects, this alignment may be most accurate when the first and second cameras are positioned as close to each other as possible. In some aspects, the means for aligning the first image and the second image may include a processor.

At block 660, the method includes using the second image to up-sample the depth information from the first resolution to a third resolution, wherein the third resolution is higher than the first resolution. For example, the second image may be used to up-sample, by snapping to edges and other geometry, such that the depth information may effectively be converted to a higher resolution. In some aspects, this may enable the depth information to be converted to the resolution of the image captured by the high-resolution second camera. In some aspects, the means for using the second image to up-sample (the upsampling means) may include a processor.

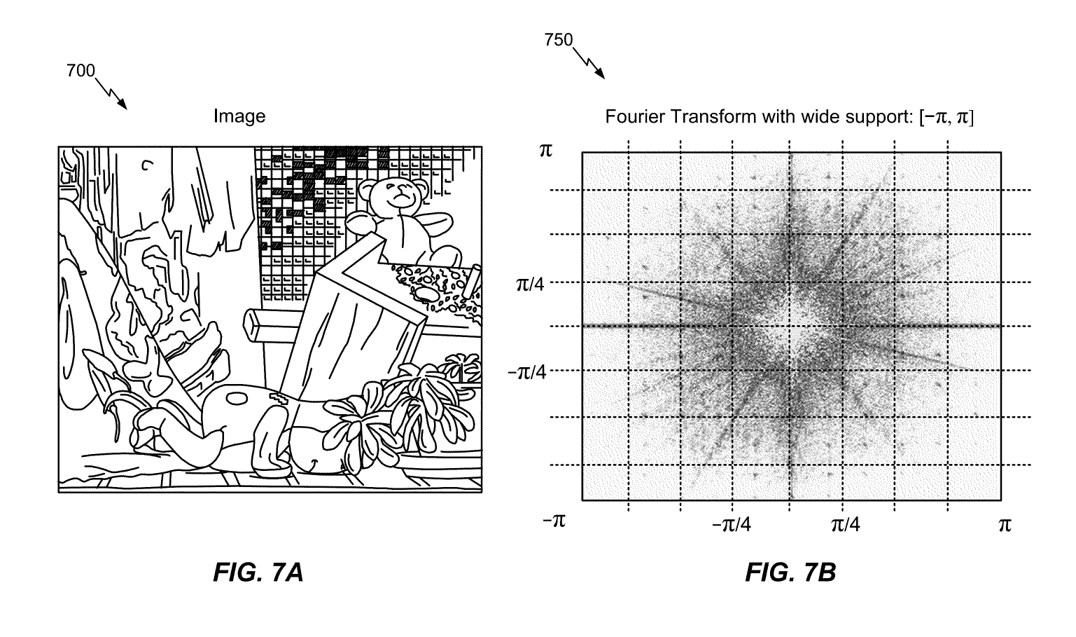

FIG. 7A illustrates a representation of a true color image containing a number of objects. FIG. 7B shows an illustration 750 of the various component bands found in image 700, generated by taking a Fourier transform of image 700 with wide support, from −π to +π. As shown by illustration 750, image 700 contains a large number of different bandwidths, extended well outward from the center of the image at [0, 0]. Generally, band-limited components of an image are near the center of the image at [0, 0], while high-pass components may be defined as components that are more distant from the center of the image at [0, 0]. Accordingly, as illustrated here, true color images contain a relatively large amount of high-pass components. Thus, in certain aspects, it may be difficult to up-sample true color images while retaining high quality, as these high-pass components may be lost in upsampling.

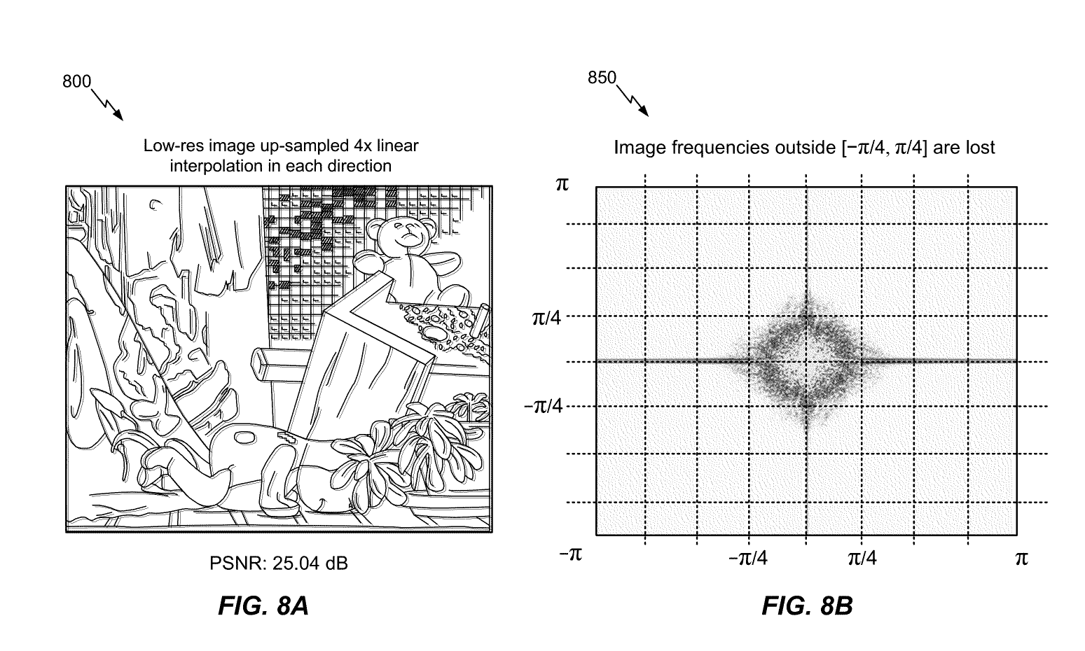

FIG. 8A illustrates a representation of a true color image 800 containing a number of objects, and was generated in a manner similar to certain methods contained in this disclosure. For example, image 800 may correspond to image 700, except that image 800 has been downscaled, and then upsampled to 4× using linear interpretation. FIG. 8B is an illustration 850 of the various component bounds found in image 800, generated by taking a Fourier transform of image 800. As shown in illustration 850, image frequencies outside the range of [−π/4, π/4] are lost due to the upsampling. Because image 800 and image 700 are identical except for the upsampling, the differences between illustration 750 and illustration 850 are solely due to the effects of this upsampling.

As shown in image 800, these lost frequencies contain a larger amount of information about, for example, the texture of various objects. Because this information is contained in higher frequency bands (higher in absolute value—outside the [−π/4, π/4] range) not found in the upsampled image, that information has been lost and is not contained in the upsampled image. As indicated next to image 800, this image contains a PSNR of 25.04 dB, which is very low compared to the previously-illustrated disparity maps. Accordingly, it may be observed based on the differences in the component bands and the low PSNR that image 800 lost a significant amount of information compared to image 700. Accordingly, it may not be desirable to upsample true color images in this manner, due to lost information greatly affecting the quality of the image, resulting in a blurry image which lacks details such as patterns.

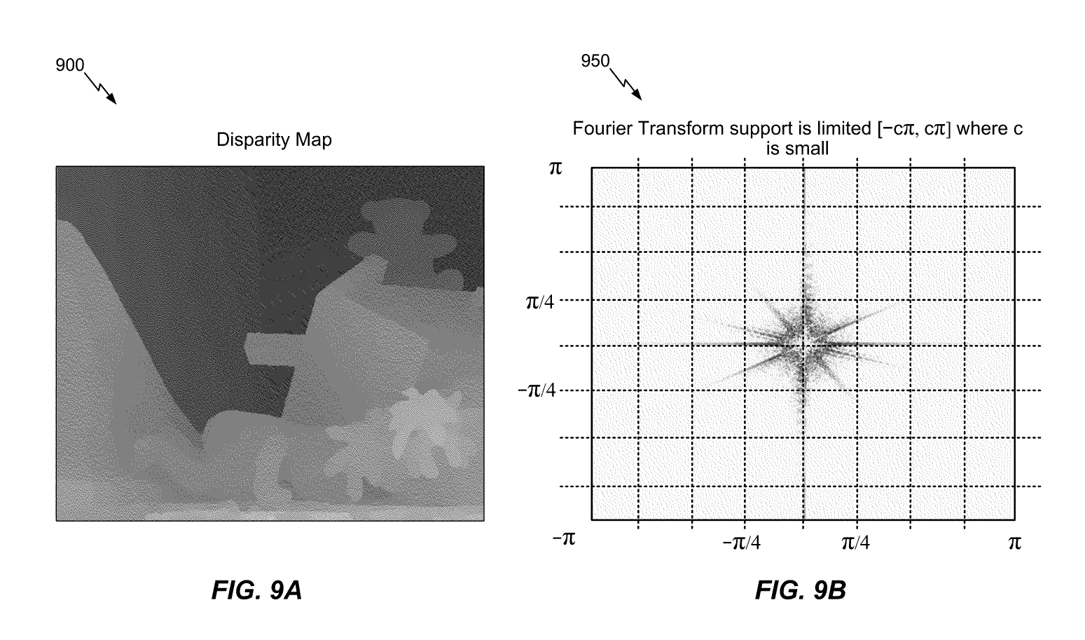

FIG. 9A illustrates an example of a depiction of a disparity map 900 generated using a global minimization method, such as an active sensing technique operating at a high resolution. The disparity map 900 was created by using the global minimization method to create the entire image, without any interpolation. For example, this disparity map 900 may have been created using a device as illustrated in FIG. 4. FIG. 9B is an example of an illustration 950 of a Fourier Transform of disparity map 900. It may be noted that illustration 950, unlike illustration 750, contains very little information outside of a [−cπ, cπ] range, where c is a small value. This lack of information may relate to a difference between true-color images and disparity maps. True-color images contain a large amount of, for example, object textures and other information which may vary the color of a particular area on a pixel-to-pixel basis. In contrast, disparity maps contain much less pixel-to-pixel variation in depth. Instead, a disparity map may instead primarily have sharp changes, relating to the edge of objects, and gradual gradients relating to variations in distance on different points on a shape (for example, the shape of a stuffed animal). Thus, as illustrated, a disparity map may be piece-wise constant, and mostly consists of only a band-limited component comprising object silhouettes and sharp edges. Due to the band-limited nature of a disparity map, a disparity map that has been recreated through upsampling, unlike a true-color image created through upsampling, may much more faithfully recreate the full-size version, without losing as much information.

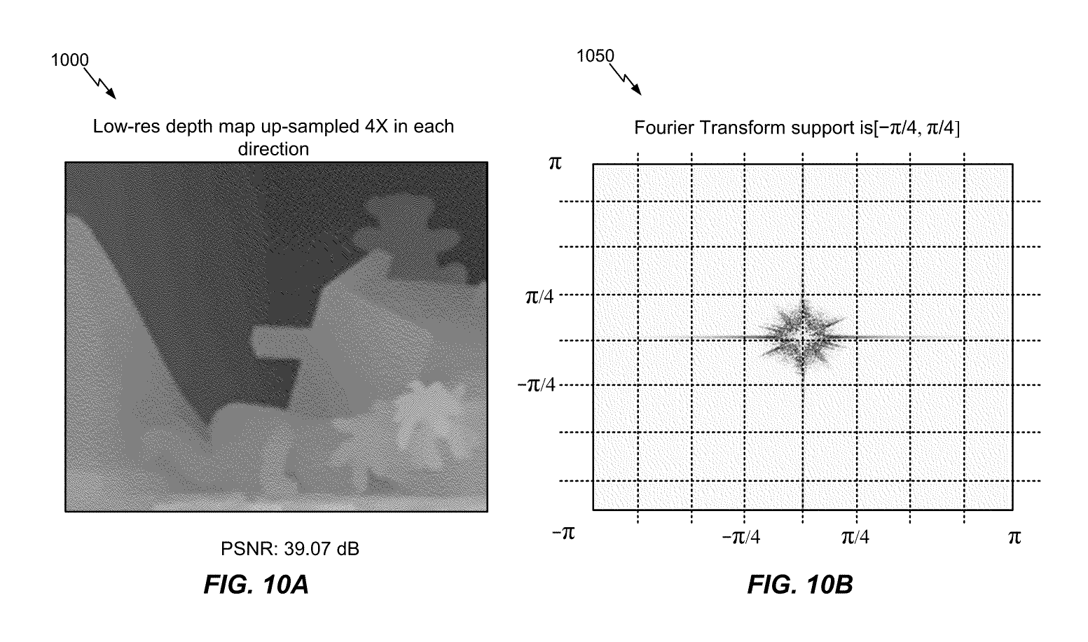

FIG. 10A is an illustration of a disparity map 1000 that has been produced through linear interpolation, but without the use of edge sharpening. Linear interpolation may be one method of upsampling an image such as a disparity map. For example, this disparity map 1000 has been produced by upsampling a low-resolution depth map by 4× in each direction, such as from 160×120 to 640×480. Because this disparity map 1000 has been upsampled, it may be observed that the edges between various objects in the disparity map 1000 are blurry. FIG. 10B is an illustration 1050 of a Fourier Transform of the disparity map 1000 produced through linear interpolation. As in illustration 850, the upsampled nature of disparity map 1000 (which was produced through linear interpolation at 4×) means that the resulting illustration shows a band-limited spectrum from [−π/4, π/4]. However, because a disparity map does not have the level of fine pixel-to-pixel detail that a natural color image may have, it may be observed that much less information has been lost from the disparity map due to upsampling from a smaller version (compared to generating the larger version through continued use of a global minimization method) than is observed in an upsampled true color image. This may be observed by noting that the difference between illustration 950 and illustration 1050 is much smaller than the difference between illustration 750 and illustration 850. Further, it may be observed that the PSNR of image 1000 is 39.07 dB, compared to only 25.04 dB in image 800. Thus, disparity map 1000 may represent a much better re-creation of disparity map 900 than may be observed using the same technique in true-color images. Accordingly, the upsampling techniques herein may work much better on depth maps than they may work on true color images.

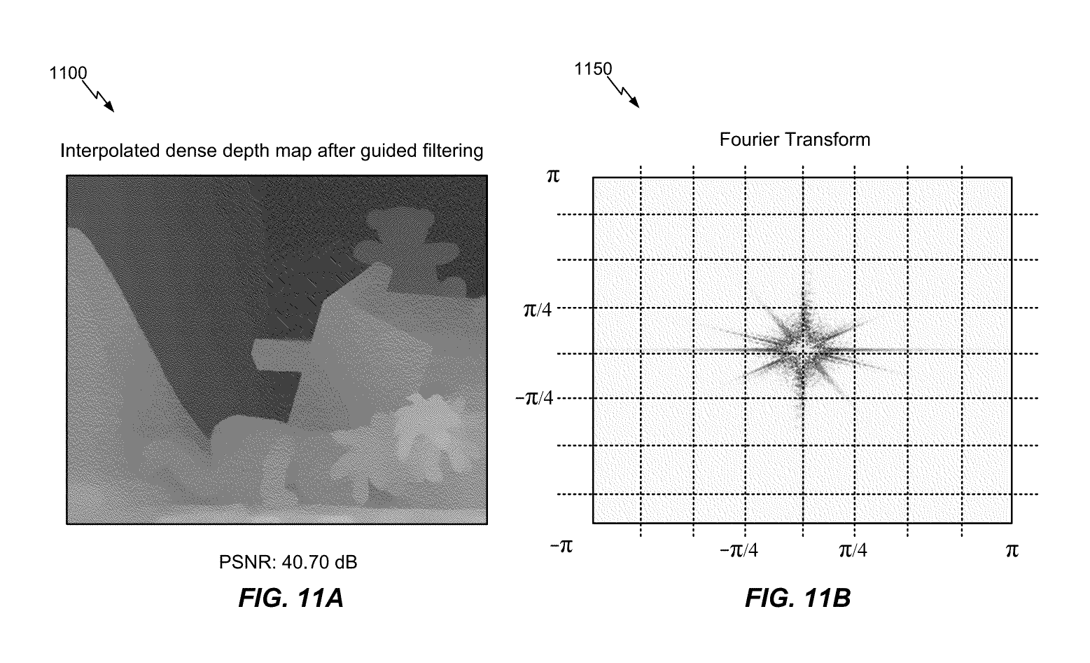

An interpolated disparity map, such as disparity map 1000, may be further improved by using a high-resolution image to sharpen the edges of the disparity map. FIG. 11A is an illustration of a disparity map 1100 which has been produced by upsampling a smaller disparity map and using guided filtering to sharpen the edges based upon a high-resolution image. FIG. 11B is an illustration 1150 of a Fourier Transform of the disparity map 1100 produced through linear interpolation. As shown, illustration 1150 is very similar to illustration 950. For example, disparity map 1100 has a PSNR of 40.70 dB, which means that this disparity map is an accurate re-creation of disparity map 900. Accordingly, it may be observed that a depth map which has been upsampled using at true-color image may be nearly as accurate as a depth map which was created originally at a higher resolution using an active sensing technique. Accordingly, since upsampling may be less computationally intensive and it may be possible to achieve higher resolutions through upsampling than through pure active sensing techniques, upsampling depth maps may be desirable.

In some aspects, a lower-resolution depth map may be upsampled using a modified SUSAN (smallest univalue segment assimilating nucleus) filter. For example, such a filter is described in Siddiqui, H., & Bouman, C. A. (2007), Training-based descreening. Image Processing, IEEE Transactions on, 16(3), 789-802. For example, linear interpolation may be used to upsample a low-resolution depth map to the resolution of a reference image, such as a high-resolution true color image. Generally, the method may use pixels of similar color in a local window for filtering a linearly-interpolated depth map. The coefficients may be guided based upon the high-resolution color image.

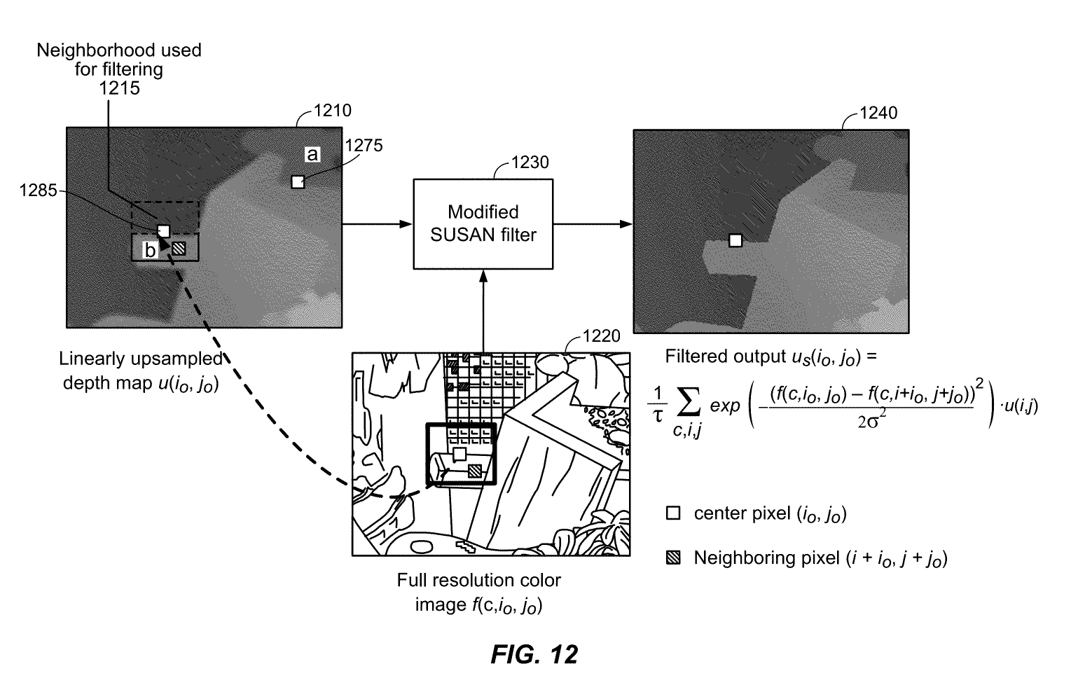

For example, as illustrated in FIG. 12, a neighborhood 1215 used for filtering may be selected, based on the linearly upsampled depth map u(i₀,j₀) 1210. As illustrated, this neighborhood 1215 may include a number of points around a given pixel, where those points have similar depth values as the given pixel. For example, the center pixel may be (i₀,j₀), and neighboring pixels, such as (i+i₀,j+j₀) may be chosen, based at least in part on proximity to the center pixel and based at least in part on similar depth values as the center pixel. These same points may then be located in the full resolution color image 1220, f(c,i₀,j₀). Accordingly, the values from the linearly upsampled depth map 1210 and the full resolution color image 1220 may be used as input values for a modified SUSAN filter 1230, in order to create the final depth map 1240. For example, the modified SUSAN filter may base an output in the final depth map 1240 based on the formula:

$$\frac{1}{τ} {\sum }_{c , i , j} exp ( - \frac{( f ( \text{?} , {i}_{o} , {j}_{o} ) - f ( \text{?} , i + {i}_{o} , j + {j}_{o} ) ) \text{?}}{2 {σ}^{2}} ) \cdot u ( i , j )$$

$$\text{?} \text{indicates text missing or illegible when filed}$$

where τ is a normalizing factor to ensure that the filter weights add up to 1, where σ is a threshold for measuring pixel similarity, where f(c,x,y) is the pixel color in the full-resolution image at a pixel at coordinates (x,y), and where u(x,y) is the depth value at a pixel at coordinates (x,y).

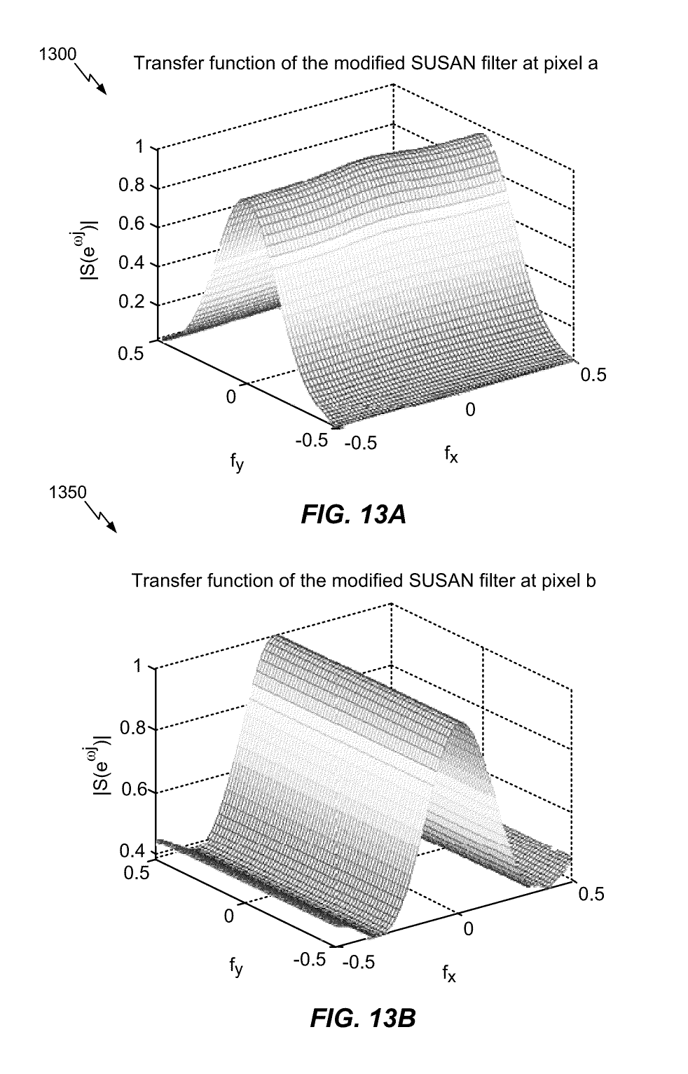

FIG. 13A is an illustration 1300 of a frequency response of a SUSAN filter, at point A 1275 of FIG. 12. A SUSAN filter is a spatially-adaptive low-pass kernel whose frequency response at a given pixel location matches that of the local image content. For example, point A is located on a horizontal boundary (along the x-axis) between two different regions, of different color/depth. Accordingly, illustration 1300 applies more weight to pixels that are similar in color/depth to pixel A and less weight to pixels that are different in color/depth from pixel A. FIG. 13B is an illustration 1350 of a frequency response of a SUSAN filter, at point B 1285 of FIG. 12. This frequency response may be used, at least in part, to determine weight of each pixel in the neighborhood of the given point. For example, point B is located on a vertical boundary (along the y-axis). Accordingly, illustration 135 applies more weight to other pixels which are along the same boundary, and less weight to pixels that are not on this boundary, such as those which are on either side of the boundary.

### Implementing Systems and Terminology

Implementations disclosed herein provide systems, methods and apparatus for multiple aperture array cameras free from parallax and tilt artifacts. One skilled in the art will recognize that these embodiments may be implemented in hardware, software, firmware, or any combination thereof.

In some embodiments, the circuits, processes, and systems discussed above may be utilized in a wireless communication device. The wireless communication device may be a kind of electronic device used to wirelessly communicate with other electronic devices. Examples of wireless communication devices include cellular telephones, smart phones, Personal Digital Assistants (PDAs), e-readers, gaming systems, music players, netbooks, wireless modems, laptop computers, tablet devices, etc.

The wireless communication device may include one or more image sensors, two or more image signal processors, a memory including instructions or modules for carrying out the CNR process discussed above. The device may also have data, a processor loading instructions and/or data from memory, one or more communication interfaces, one or more input devices, one or more output devices such as a display device and a power source/interface. The wireless communication device may additionally include a transmitter and a receiver. The transmitter and receiver may be jointly referred to as a transceiver. The transceiver may be coupled to one or more antennas for transmitting and/or receiving wireless signals.

The wireless communication device may wirelessly connect to another electronic device (for example, a base station). A wireless communication device may alternatively be referred to as a mobile device, a mobile station, a subscriber station, a user equipment (UE), a remote station, an access terminal, a mobile terminal, a terminal, a user terminal, a subscriber unit, etc. Examples of wireless communication devices include laptop or desktop computers, cellular phones, smart phones, wireless modems, e-readers, tablet devices, gaming systems, etc. Wireless communication devices may operate in accordance with one or more industry standards such as the 3rd Generation Partnership Project (3GPP). Thus, the general term “wireless communication device” may include wireless communication devices described with varying nomenclatures according to industry standards (e.g., access terminal, user equipment (UE), remote terminal, etc.).

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (for example, a “program”) that may be executed, processed or computed by the computing device or processor. As used herein, the term “code” may refer to software, instructions, code or data that is/are executable by a computing device or processor.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (for example, receiving information), accessing (for example, accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

In the foregoing description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

Headings are included herein for reference and to aid in locating various sections. These headings are not intended to limit the scope of the concepts described with respect thereto. Such concepts may have applicability throughout the entire specification.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. A method of generating a high-resolution image containing depth information of an object, the method comprising:
capturing a first image of a scene using a first camera, the captured image including light projected in a known pattern on the scene;
determining depth information at a first resolution from the first image;
capturing a second image of the scene using a second camera, the second image captured at a second resolution which is higher than the first resolution;
adjusting the depth information to be from a different viewpoint; and
up-sampling the depth information, using the second image, from the first resolution to a third resolution to generate depth information at the third resolution, the third resolution higher than the first resolution.

2. The method of claim 1, wherein adjusting the depth information to be from a different viewpoint comprises re-rendering the depth information as if the first image was taken from the second camera position.

3. The method of claim 1, wherein adjusting the depth information to be from a different viewpoint comprises re-rendering the depth information from the first image after adjusting the first image based on at least one difference in a projected field-of-view of the first camera and a projected field-of-view the second camera.

4. The method of claim 1, wherein the depth information comprises a depth map, and wherein up-sampling the depth information comprises using edge information in the second image to adjust at least a portion of the depth map.

5. The method of claim 1, wherein the first image depicts codes reflected from at least one object illuminated by a structured light transmitter, and wherein the second image is formed from visible light.

6. The method of claim 1, further comprising projecting light in a known pattern on the scene.

7. The method of claim 1, wherein the third resolution is substantially equal to the second resolution.

8. The method of claim 1, further comprising determining at least one difference between a position and field of view of the first camera and the second camera, and wherein adjusting the depth information is based on the at least one difference.

9. The method of claim 1, wherein the first image comprises a near infrared image and the second image comprises a color image.

10. The method of claim 1, wherein the known pattern is produced by a diffractive optical element positioned to receive a light beam emitted from a laser, the diffractive optical element including a plurality of diffractive features configured to produce the known pattern when the light beam from the laser propagates through the diffractive optical element.

11. A depth sensing system, comprising:
a transmitter configured to project a known pattern of light;
a receiver comprising a sensor assembly configured to capture a first image of an object illuminated by the known pattern of light, the first image being at a first resolution;
a camera positioned proximate to the receiver, the camera configured to capture a second image of the object using visible light; and
a processor configured to
determine depth information at a first resolution from the first image, the depth information determined based at least in part on the known pattern of light;
adjust the depth information to be from a viewpoint of the camera; and
up-sample the depth information, using the second image, from the first resolution to a third resolution to generate depth information at a third resolution, the third resolution being higher than the first resolution.

12. The system of claim 11, further comprising determining at least one difference between a field of view of the receiver and the camera, and wherein adjusting the depth information is based on the at least one difference.

13. The system of claim 11, wherein the transmitter comprises a near-infrared transmitter and the receiver comprises a near-infrared receiver.

14. The system of claim 11, wherein the depth information comprises a depth map.

15. The system of claim 14, wherein the processor is further configured to up-sample the depth information using edge information in the second image.

16. The system of claim 11, wherein the third resolution is substantially equal to the second resolution.

17. The system of claim 13, wherein the second image is a color image.

18. A device for generating a high-resolution image containing depth information of an object, the device comprising:
a first camera configured to capture a first image of a scene, the captured image including light projected in a known pattern on the scene;
a second camera configured to capture a second image of the scene, the second image captured at a second resolution which is higher than a first resolution;
a processor configured to:
determine depth information at the first resolution from the first image, the depth information determined based at least in part on a pattern of the projected light in the first image;
adjust the depth information to be from a different viewpoint; and
up-sample the depth information, using the second image, from the first resolution to a third resolution to generate depth information at the third resolution, the third resolution higher than the first resolution.

19. The device of claim 18, wherein the projected light comprises near infrared light.

20. The device of claim 18, further comprising a laser configured to project light in the known pattern on the scene.

21. The device of claim 18, wherein the third resolution is substantially equal to the second resolution.

22. The device of claim 18, wherein adjusting the depth information to be from a different viewpoint comprises re-rendering the depth information as if the first image was taken from a position of the second camera.

23. The device of claim 18, wherein the first image comprises a near infrared image and the second image comprises a color image.

24. The device of claim 18, wherein the known pattern is produced by a diffractive optical element positioned to receive a light beam emitted from a laser, the diffractive optical element including a plurality of diffractive features configured to produce the known pattern when the light beam from the laser propagates through the diffractive optical element.

25. A device for generating a high-resolution image containing depth information of an object, the device comprising:
means for capturing a first image of a scene using a first camera, the captured image including light projected in a known pattern on the scene;
means for determining depth information at a first resolution from the first image;
means for capturing a second image of the scene using a second camera, the second image captured at a second resolution which is higher than the first resolution;
means for adjusting the depth information to be from a different viewpoint; and
means for up-sampling the depth information, using the second image, from the first resolution to a third resolution to generate depth information at the third resolution, the third resolution higher than the first resolution.

26. The device of claim 25, wherein the projected light comprises near infrared light.

27. The device of claim 25, further comprising means for projecting light in the known pattern on the scene.

28. The device of claim 25, wherein the third resolution is substantially equal to the second resolution.

29. The device of claim 25, wherein the first image comprises a near infrared image and the second image comprises a color image.

30. The device of claim 25, wherein the known pattern is produced by a diffractive optical element positioned to receive a light beam emitted from a laser, the diffractive optical element including a plurality of diffractive features configured to produce the known pattern when the light beam from the laser propagates through the diffractive optical element.
